(19) United States
(12) Patent Application Publication
(10) Pub. No.: US 2020/0167326 A1
(43) Pub. Date: May 28, 2020

(54) SYSTEM AND METHOD FOR ACTING ON POTENTIALLY INCOMPLETE DATA

(71) Applicant: BMLL Technologies, Ltd., London (GB)

(72) Inventor: Hugh L. Christensen, London (GB)

(73) Assignee: BMLL Technologies, Ltd., London (GB)

(21) Appl. No.: 16/719,887

(22) Filed: Dec. 18, 2019

Related U.S. Application Data
(60) Provisional application No. 62/910,330, filed on Oct. 3, 2019.

(51) Int. Cl. G06F 16/22; G06F 9/54

(52) U.S. Cl. CPC G06F 16/2228; G06F 9/541

(57) ABSTRACT

A system and method for collecting and using data are provided, in which an alignment of the different type of data may be needed in real time. The method collects data from data sources of a variety of sources, about which, it is not necessarily known in advance which data at the source matches the data desired or how the data will be labeled or organized. The data may be normalized and the information from potentially multiple data sources may optionally be consolidated. Then the method may retrieve a smaller amount, and/or less complex set, of data, which may be private data, and the method may align the retrieved data with a larger, and/or more complex set, of data (which may be public data). The smaller amount of data and the larger and/or more complex data are used to compute an index, and the index may then be used to align future sets of the smaller amount of data with the later sets of the more larger or complex data.

### CROSS REFERENCE TO RELATED APPLICATIONS

This application claims priority benefit of U.S. Provisional Patent Application No. 62/910,330 (Docket Number BY-4), entitled “SYSTEM AND METHOD FOR ACTING ON POTENTIALLY INCOMPLETE DATA,” filed on Oct. 3, 2019, by Hugh L. Christensen, which is incorporated herein by reference.

### FIELD

This specification generally relates to systems and methods for acting on data.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

The advent of big data and increasing technological advancements and complexities continue to transform the way various systems and devices operate. This specification recognizes that data may be stored in the various data sources, and it is a challenge to collect the continuously changing data (e.g., private data) align the data with other data (e.g., public in real-time) and present meaningful data upon which meaningful decisions and actions may be taken (e.g., in real-time or in near real time). Additionally, it is recognized in this specification that the sources of the data may store the data in formats that are not known in advance and may label the data with labels that are not known in advance further complicating the usefulness of automatically making sense of the data so that appropriate actions may be taken (e.g., in real time).

### BRIEF DESCRIPTION

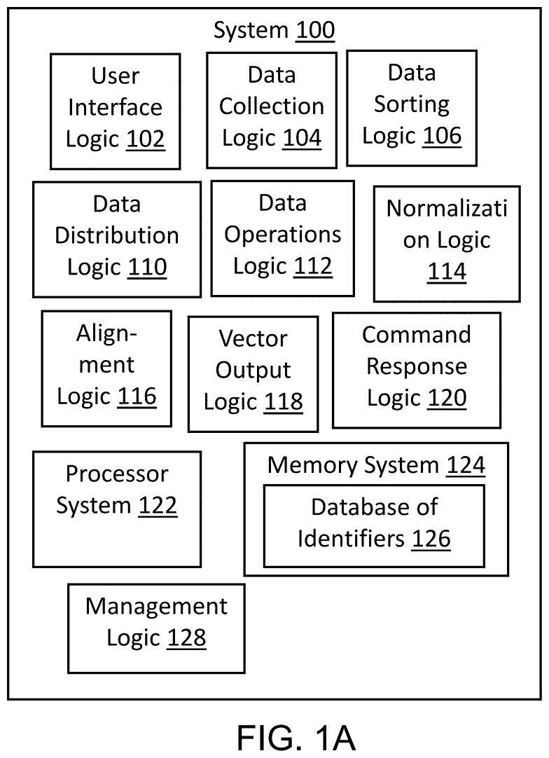

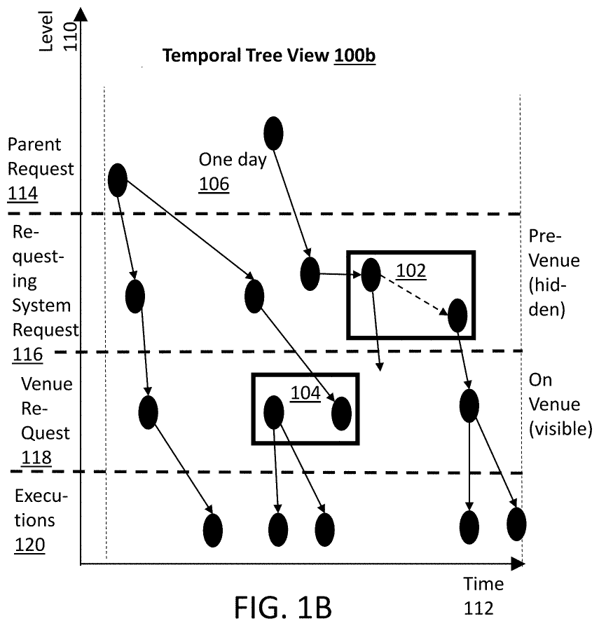

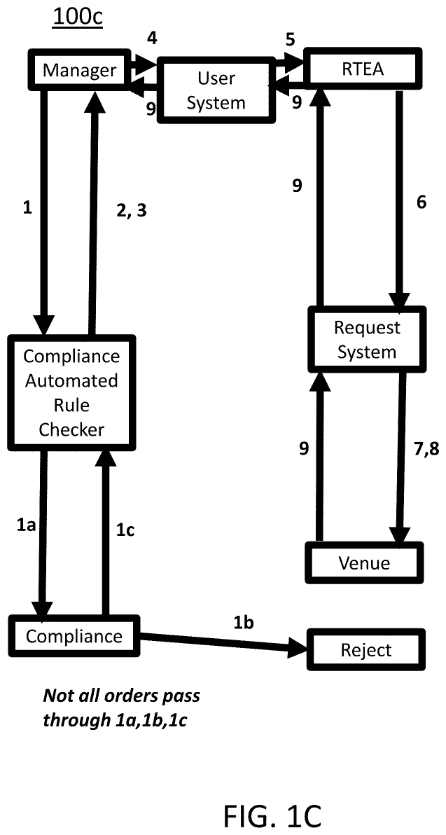

FIG. 1A shows a block diagram of an embodiment of a system for collecting and using data.

FIG. 1B shows a chart that illustrates the hierarchy formed by a parent request, child request, venue request, and fills of the requests.

FIG. 1C shows the flow of a request that is submitted to a venue.

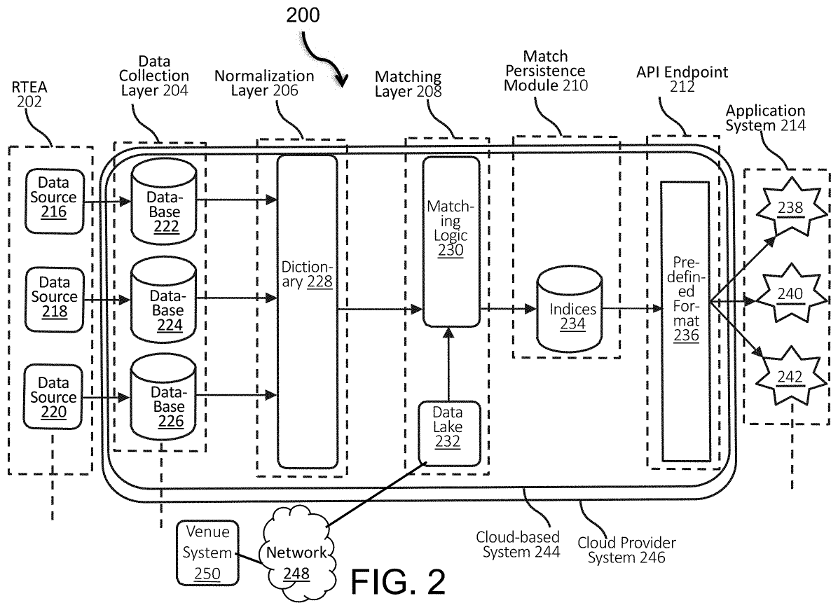

FIG. 2 shows a block diagram of an embodiment of system for collecting and using data.

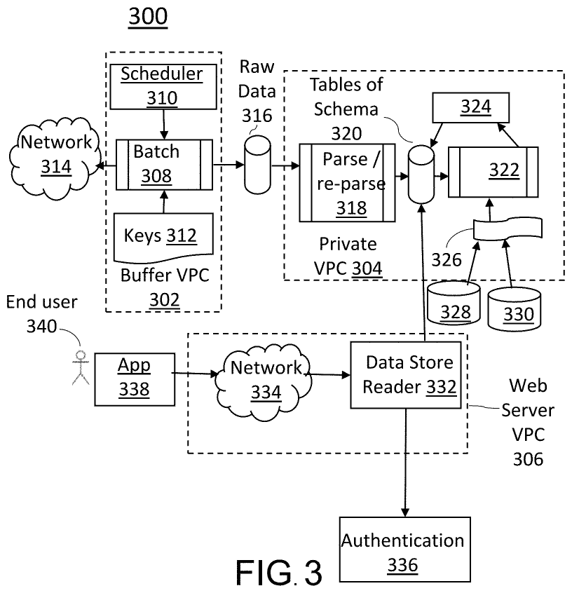

FIG. 3 shows a block diagram of an embodiment of a system for collecting and using data.

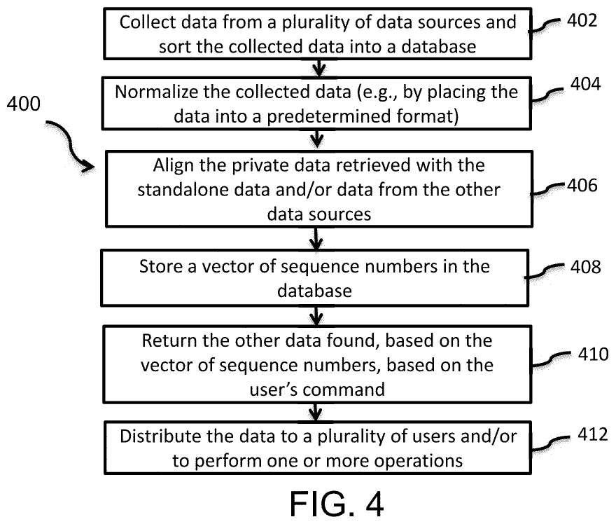

FIG. 4 is a flowchart of an example of an embodiment of a method for collecting and using data.

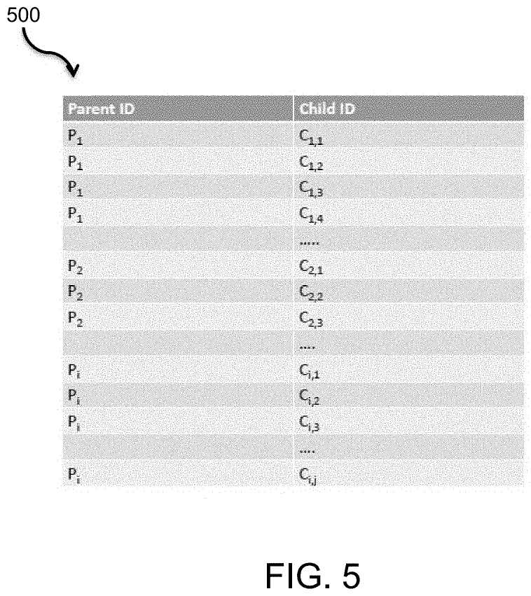

FIG. 5 show a representation of an object in which parent requests and child requests have been aligned.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

FIG. 1A shows a block diagram of an embodiment of a system 100 for collecting and using data. The system 100 may include a user interface logic 102, data collection logic 104, data sorting logic 106, data distribution logic 110, data operations logic 112, normalization logic 114, alignment logic 116, vector output logic 118, command response logic 120, processor system 122, memory system 124 having database of identifiers, and management logic 128. In other embodiments, the system 100 may not have all of the elements or features listed and/or may have other elements or features instead of or in addition to those listed.

FIG. 1A depicts a system 100 that may be used to present continuously changing data (e.g., private data) aligned with other data (e.g., public data) and presents meaningful data upon which meaningful decisions and actions may be taken.

System 100 is a system for collecting and using data. System is optimized for collecting the data from large data sources in which the data is continually changing at a fast rate on at least periodic basis, and the data collected may be needed in real time or in near real time. In an embodiment, near real time is a period of time less than a minute. In another embodiment, near real time is a period of time less than two seconds. In another embodiment, near real time is a period of time less than one second. In an embodiment, near real time is a time period less than 4 milliseconds. In an embodiment, near real time is a time period less than or equal to 3 milliseconds. In an embodiment, near real time is a time period less than or equal to 2 milliseconds. The periodicity at which the data is updated continually may be eight hours out of every business day, or the data may continually updated continually, for example. In at least one embodiment of system 100, data is collected from a plurality of sources, and system 100 places the data collected into a cloud database. Optionally, the data (e.g., the private data) may be updated in real time as the data is being collected. Optionally, the data may be collected from a variety of sources, via a wide area network (e.g., the Internet), a network of machine components, and/or via a cloud computing system. Optionally, the data may include database transactions, memory transactions, and/or other data, for example. After collecting and aligning the data, the data optionally may be distributed to a variety of interested parties, which may need the aligned data in real time or near real time. One or more of the interested parties may have a Real Time Execution Application (RTEA) for accessing data and/or performing operations (e.g., executing operations) based on the data, such as database transactions, in real time and/or near real time.

Each source may have a different form and/or format in which the data is stored. Optionally, one or more sources may store the data in a database (e.g., a relational database and/or other database). Those sources of data that use databases may use different database schema, reflecting the different information and fields stored in that data source. Each data source may have been selected for different reasons, and the attributes and/or fields may be reflective of the purpose of the data source. Some examples of types of databases that may be used by the data sources are Amazon Web Services (AWS), Relational Database Service (RDS), and/or PostgreSQL (PG) (PostgreSQL is Sequential Query Language (SQL) for a Postgre database, which is an open source database. Each data source may have a variety of advanced encryption mechanisms in place. Optionally, one are more sources may include two categories of data, which are deep history (which may be processed and/or access by batch jobs) and real-time and/or near real-time data (e.g., which may be accessed via a web Application Program Interface (API) in real time and/or near real time). The process of getting the data from a user's RTEA into a database (or other data storage facility), which may optionally be located in the cloud (AWS), and which optionally requires the use of a range of data in transit encryption mechanisms, such as Pretty Good Privacy (PGP) and/or Secure Sockets Layer (SSL).

Optionally the data collected from the plurality of sources may be normalized, to consolidate the information across the sources. The normalization of the data may include placing the data into a predetermined format and labeling the data with a standardized label that is the same no matter the source of the data.

Private data may be retrieved from individual users (e.g., the interested parties). The private data retrieved from the plurality of sources may then be aligned with publicly available data from the other data sources (which optionally includes transactions and which optionally includes real-time or near real-time data). The publicly available data may be anonymous. In other words, in the publicly available data, the identities of the parties executing the trade are not made public. The publicly available data may be referred to as standalone data. The alignment may include matching the identifiers of one database with the identifiers (such as by matching the identifiers that may be the names of attributes and/or fields of database objects, for example). The alignment may be deterministic, stochastic, or a combination of deterministic and stochastic alignments. In cases in which the private data contains a known identifier, then the alignment is deterministic. In at least one embodiment, a deterministic alignment is a rare event, because the data (e.g., and an associated database) may have a complex structure. The structure of the data may, in-part, be dependent on time—data captured recently and/or data that is in the process of being changed may be stored in one set of locations, and older data may be stored in other locations. There may be a variety of variables that are of interest. The variables may be stored and/or may be derivable from the data. A variable may correspond to an attribute (e.g., a column) of a database. Hence, often the value of a variable may be a known identifier of a type of data that is used by the user, which may be lost because there is no one piece of data that clearly corresponds to the identifier and/or there is may not be any one piece of data that completely corresponds to the identifier. Optionally, if the data cannot be matched deterministically, the data is matched stochastically. In the case that the data is matched stochastically, the present method may align the private data against the publicly available data from other data sources based on the variables which might be missing, lack accuracy, and/or the match may not be unique. In an embodiment, the present method utilizes fuzzy matching to perform the stochastic alignment. Specifically, the fuzzy matching may automatically process word-based the identifiers of the user (which identify a particular type of data) to find a matching identifier used in the data. The identifiers may be individual words, phrases, or even entire sentences. The identifier in the data found and the identifier of the user are not necessarily of the same length or type, for example. The identifier of the data found may be a single word, whereas the identifier that the user found may be an entire sentence or phrase, for example. The reverse may also be true. In other words, the identifier of the user may be a single word, whereas the identifier of the data found may be an entire sentence or phrase, for example. During the matching, that system finds a match for a sentence or phrase, although the match may be less than 100% certain. For example, a probability that a match exists may be computed, and if the probability is above a preset threshold, the data found is presented to the user as a possible match. Optionally, a percentage representing the expected likelihood that the two sets of data match is also presented to the user. There may be multiple sets of data found that are returned as possible matches for a single identifier of data of the user. In addition, one set of data found may be presented as possible matches for several different identifiers of data of the user. Optionally, the method may search a database of possible different identifiers that may be used to represent the same type of data, which may be associated with values representing the frequency that the two descriptions or two sets of one or more words (one set from the identifiers of the user and one set from the identifiers of the data found) are used to describe the same data. Optionally, the range of values of the data of the user and the data found may also be checked to determine whether the values are in an expected range or generally within the same range to determine a likelihood that the two sets of data represent the same data and/or, even if there is no user data, the range of the data that may be found may be checked, to determine if the data found is the type of data sought. For example, certain types of events may only occur during certain times, and the data may be check to determine if the values are in a format that time is usually presented and whether the range of times in the data matches the range of times during when those activities would likely occur. Other statistical parameters of the data may be checked, such as the mean, the mode, the standard deviation, the variance, the distribution of the data, the change in the data with time, the change in the mean with time, the change in the mode with time, the change in the standard deviation with time, and/or the change in the distribution of the data with time may be checked to determine the likelihood that the data found is the data sought. Checking any of the prior listed parameters for changes with time may include checking the first derivative, second derivative, and/or higher derivatives with respect to time. The method checks and stores private data. The publicly available data of identifiers that were previously found to correspond may also be stored and checked. Then the method may match identifiers by suggesting words with approximate matching meanings as well as spellings and misspellings. Optionally, user input may be sought to determine whether a user identifier corresponds to a particular type of data found. In an embodiment, more information may be discovered in the process of determining a match between identifiers, which may warrant rechecking whether the match is the best match for a particular user identifier of data, which may cause a cycling backward and forwards, assigning probabilities to different alignments of data.

For example, given a private observation instance xᵢ that occurs at time tᵢ, which may have one or more dependent parameters, it is assumed that the private observations xᵢ have a time stamp synchronization error with a known distribution of known parameters, for example, Γ(α, β). Inside a window defined by the distribution, the matches occur, and the matches are assigned probabilities of being correct. For example, there may be a probability assigned to a variety of observations recorded at the other database of being the same as observation xᵢ, which may be a product of the probability that two names of the identifiers (that of the user and that of another database) represent the same thing and the probability that difference in time recorded by the user and the other database are due to the times not being synchronized. Then a search is performed for xᵢ₊₁ and probabilities are assigned to the candidates found. In doing the second step, the present method recalculates the first step if there are overlapping probability windows and/or non-unity probabilities assigned. For example, the probabilities may be normalized so that all probabilities are normalized to unity, and then the probability may be recomputed based on the new normalization. The process of matching a user identifier with data found may be a variant of an Expectation-Maximization (EM) algorithm. The process of matching user identifiers with data found may be computationally demanding, and so the matching may be done on a batch basis using a distributed server farm with calculations performed for an individual item of interest for each date. Optionally, although the index that results from the matching is created less often than the private and public information are matched, whether during the creation of the index or whether using the index to create a match, the threshold values for what is an acceptable match may be adjusted according to how quickly the alignment needs to be computed.

An Expectation-Maximization (EM) algorithm may be used to find maximum likelihood that estimates of parameters in statistical models with hidden variables (usually missing data or latent variables). Further, in an embodiment, the algorithm for finding a match between a user identifier and data found may involve iteratively computing expectations that the data is a match, which may be computed as a log function and then solving for the maximum likelihood parameters. It may be convenient to represent the maximum likelihood as log function, because a log function has the property that log(f(X)g(Y)h(Z))=log(f(X))+log(g(Y))+log(h(Z)). Generally, with observations Xᵢ and latent variables Zᵢ, (e.g., unobserved variable) the log-function as follows:

$$l ( θ ) = {\sum }_{i = 1}^{N} log ( p ( {x}_{i} \text{\textbar} θ ) ) = {\sum }_{i = 1}^{N} ( {\sum }_{{z}_{i}}^{N} log ( p ( {x}_{i} , {z}_{i} \text{\textbar} θ ) )$$

where, l(θ) is the likelihood,
xᵢ—is the observed variables,
zᵢ—Latent (unobserved) variables, and
θ is a parameter of variables l, xᵢ, and zᵢ—that is l, xᵢ, and zᵢ may be unknown functions of θ. The parameter θ may be the time, proportional to the time, and/or otherwise related to the time, for example.

The output of the alignment step may be a plurality of vectors of sequence numbers, which maps the sequential private observations to publicly available data from the other data sources. The sequence numbers are unique values that may be created in the data sources. The sequence numbers may be generated by incrementing values and returning the results of incrementing the value. Each element of data may be assigned a sequence number, to uniquely identify the elements of the data. For example, if the data includes a series of transactions, each transaction may be assigned a sequence value, so that two elements of data, such as two events or two transactions that otherwise may look identical can be distinguished from one another.

Similarly, to avoid isolation of an element of data (e.g., to avoid transaction isolation), each sequence number is unique (and as mentioned before, each element of data is assigned a sequence number). “Isolation,” in this context, refers to mistaking a unique element of data for a duplicate of another element of data and therefore leaving that piece of data out of the data set (in “isolation”). As a result of using the sequence numbers, the tuples representing the data are unique, and several tuples of elements of data (e.g., transactions) will not have the same value. In an embodiment, to avoid errors, the increments of the sequence numbers cannot be rolled back.

Further, the method may include a step of storing the vector of sequence numbers. The sequence numbers may be the user-defined schema-bound object that generates a sequence of numeric values that are used to label the data collected. The sequence numbers are bound to a schema (and may therefore be said to be schema bound) to depict a relationship between two vectors of the sequence numbers. In one vector of sequence numbers, the sequence numbers are bound to the schema of the data source, and in the other vector of sequence numbers, the sequence numbers are bound to the schema of the database of the system requesting the data. Storing the relationship of the data to the sequence numbers of the source database (the database where the data was taken from) helps prevent the loss of data and helps maintain a correlation or a proposed correlation between the data taken from the source database and the data of the user's database. In other embodiments, a vector is not used, but any mechanism of storing the relationship of the data to the source database and storing how that correlates with the user's database could be used. In other words, the vectors of sequence numbers are the indices used for aligning the newly captured private data with the public data. Storing the vectors of sequence numbers helps prevent the sequential private observations and publicly available data from being dropped or modified. The vectors of sequence numbers may be stored as long as the sequential private observations and publicly available data exist in the database. The sequence of numeric values may be generated in an ascending or descending order at a defined interval and may cycle (or otherwise repeat) as requested by the user.

The method may then include the step of returning the other data found (e.g., based on the vector output) on receiving the user's command, via the API. Returning the data found may involve returning the publicly available data from the other data sources, fetching the vector of aligned sequence numbers, fetching the private data from the user, for example, creating a database view by performing a database join across the private data of the user and the data that was matched on the fly. In other embodiments, other indices may computed and used for aligning the public and private data instead of the vectors of sequence numbers.

Optionally, extensive security measures may be taken so that one user is not accidentally shown the transactional data for another user. These security measures may include assigning an Identity and Access Management (IAM) role to each endpoint call. The Relational Database Service (RDS) instances or virtual machines may have row-level access management enabled, so that only those authorized to access a particular row/record may access that row. The database may be authenticated using Identity and Access Management (IAM) database authentication. The authentication method, may not necessarily require use a password when connecting to a database instance. Instead, an authentication token may be used. The authentication token may be a unique string of characters that is generated on request by a server and/or service provider, which may be valid for only a predetermined amount of time (e.g., 15 minutes). It may not be necessary to store user credentials in the database, because authentication may be managed externally using IAM or a similar third party authentication token. Network traffic to and from the database may be encrypted using Secure Sockets Layer (SSL).Access may be managed centrally to database resources, instead of managing access individually on each DB instance. Optionally profile credentials specific to an Elastic Cloud Computing (EC2) instance or virtual machine to access to the database instead of (or in addition to) a password may be used.

User interface logic 102 is an interface via which a user system may interface with (e.g., request and receive data from) system 100. User interface 102 may include a Graphical User Interface (GUI), which may display the collected data in real time or near real time to users, and/or display information about automated activities being performed based on the data collected.

Data collection logic 104 collects data from a plurality of data sources, which may each include a different database. Each database may have a different schema and may label data differently. Some data sources might not even have a database, but may have data stored and organized in a different fashion. For example, two data sources may have an overlap (or partial overlap) in the data stored or the type of data stored but may label the same data or the same type of data differently. The schema of each database of each data source and the labels of each data used by each database may not be known in advance. Data collection logic 104 collects the data despite the uncertainties in the data collected and optionally stores the collected data. The data that data collection 104 collects may include database transactions and/or memory transactions, for example. The collected data may originate from sources that update the data at the source in real time, and data collection logic 104 may update and collect the data in real time. The plurality of data sources may each store data in (and may each have databases) in different locations of a network (e.g., the Internet), which may include one or more cloud-based databases and/or a relational database. The plurality of data sources from which data collection logic 104 collects data may be selected based on a user system's requests and/or needs and/or the data expected to be found at each source. Data collection 104 may collect some data on demand (e.g., persona data) and may collect some data (e.g., public data) periodically, optionally at less frequent intervals (e.g., once a day).

Data sorting logic 106 is a logic unit that sorts and optionally consolidates data collected by data collection logic 104, which may potentially come from multiple data sources, which may include public data and/or private data. Data sorting logic 106 may sort data collected prior to normalization and alignment, so that the data may be more easily normalized and/or aligned. Data sorting logic 106 may also join (e.g., via a database join or via other methods) the publicly available data with the data known to the user system after the data is aligned to present one view to the user system having the data known to the user system and the publicly available data. Data sorting logic 106 is optional.

Data distribution logic 110 is a logic unit that distributes the data collected to a plurality of user systems. Data distribution logic 110 may deliver the private and the public data along with one or more of the indices, separately, to one of the user systems, and the user systems may, with the aid of one or more indices, assemble the data into one view. The data delivered and the indices delivered may optionally be in an encrypted format.

Data operations logic 112 performs operations (e.g., database operations) on the data according to the needs of the user system. A data operations logic 112 may perform the operations in real time and/or may utilize a Real-Time Execution Application (RTEA) for performing some or all of the operations.

Normalization logic 114 normalizes the collected data (which may come from a variety of sources each having its own format) by placing the data that was collected and sorted into a predetermined format, which may facilitate consolidating the information. The normalization logic may match identifiers of one or more attributes with a stored identifier that is used by system 100, based on a dictionary that associates different names of identifiers with one another.

Alignment logic 116 is a logic unit that aligns the private data of the user system with data from the plurality of sources, which may now be publicly available data from the other data sources. Optionally, the other data sources include transactions. The data may optionally include real-time or near real-time data (e.g., privet data) and other data (e.g., public data), which may not be available in real time or near real time. The alignment may include aligning the identifiers of one database with the identifiers of another database, based on one or more indices. Further, the alignment logic 116 may output a plurality of vectors of sequence numbers that map data from the data sources to the data of the user system, which may include mapping sequential private observations of associated with the user system to the publicly available data from the other data sources.

Vector output logic 118 outputs vectors of sequence numbers in one or more databases. Optionally vector output logic 118 may create the vector of sequence numbers and/or may be part of alignment logic 116. The databases may include databases of the system 100 and/or of the user systems. The vectors of sequence numbers may be used as indices for aligning different sources of data (e.g., for aligning public data and private data). Optionally, each vector of sequence number may include two or three columns. Of the two or three columns of a given vector, one column (e.g., a first column) may be a list of identifiers of rows of one data source, and another column (e.g., a second column) may be a list of rows from a second data that is aligned with identifiers of the first data source. The alignment of the first and second column may be such that two identifiers that likely correspond to the same event (e.g., the same transaction) are in the same row. There optionally, may be a third column assigning a common sequence number to each row. The first two columns (taken from the public and private data) may be sequence numbers native to the data source from which the data originated (e.g., sequence numbers native to the data produced by the RTEA and the venue).

Command response logic 120 is a logic unit that produces response to commands received from the user systems, optionally via an API. Command response logic 120 may produce, on demand, responses to commands generated from user input.

Processor system 122 may include one or more processors and may implement and/or perform the functions of user interface logic 102, data collection logic 104, data sorting logic 106, data distribution logic 110, data operations logic, normalization logic 114, alignment logic 116, vector output logic 118, and/or command response logic 120. Processor system 122 (1) return the publicly available data from the other data sources, (2) fetch the vector of aligned sequence numbers, (3), by one or more processors,) fetch the private data and for example, (4) create a database view by performing a database join across the private data and the data that was matched on the fly.

Memory system 124 may store the machine instructions implemented by processor system 122.

Database of identifiers 126 may store associations between different identifiers that facilitate recognizing which identifiers refer to the same and/or similar type so of data. Alignment logic 116 may use a database of identifiers 126 to align (e.g., match) the identifiers associated with a user system with that of the data source and/or .identifiers of private data with identifiers of publicly available data. In an embodiment, memory system 124 includes database of identifiers 126, which may that store identifiers used various databases.

Request management logic 128 (RML) is a software application for facilitating and managing the flow of requests at different execution venues. The end user may send request to a request system. The request management logic 128 may be employed both prior and after execution. The request management logic 128 may perform functions, such as allocation, managing conditional requests, and communication between managers of user's requests and users. Request management logic 128 may help ensure that requests are up-dated, reported to the user, and sent to the backend. In general, request management logic 128 looks inwards and links to records, benchmark systems, mandate tracking systems, and/or other internal applications within the requests.

A Real-Time Execution Application (RTEA) may include and/or may be an Execution Management System (EMS), which may be designed to display market data and to provide seamless and fast access to trading destinations for the purpose of transacting orders. In contrast, to a request management logic 128, an RTEA is focused on real-time requests and analytics. RTEA systems may have two logical interfaces—one for venue data and one for requests/executions. An RTEA offers the capability to manage request in multiple venues. In general, an RTEA looks outwards to allow requests in the venue.

There may be one request management logic 128 connected to many RTEA platforms. Consequently, this means that for a large request-side, there is not just connectivity from a request management logic 128 to request systems, but there is also a range of connectivity out to diverse RTEA platforms. The diversity means that any entity that attempts to manage outsourced buy-side connectivity will face the problem that the range of workflows becomes hard to manage, which is handled by the request management logic 128, thereby simplifying managing many request made with respect to many RTEA platforms and/or requests at multiple venues.

In an embodiment, request management logic 128 and RTEA may be combined into one system, request management logic 128 may performs some function of the RTEA, and/or the RTEA may perform some functions of request management logic 128. However, when performing requests in multiple venues automated requests using execution algorithms, request flows become increasingly complex, with splitting request across (or between) multiple venues, aggregated requests, requests with pending allocations, pairs, contingent requests, baskets, request programs, multiple requests from different clients in the same instrument, for example, may need to be managed and executed.

FIG. 1B shows a chart 100b that illustrates the hierarchy formed by a parent request, child request, venue request, and the fulfillments of the requests. The only information that is publicized is the filling of the request. Box 102 shows one requesting system routing a request to another requesting system through a chain. Box 104 shows a requesting system splitting an order into multiple venue orders.

FIG. 1C shows a flow 100c of a request that is submitted to a venue. Steps 1 (and steps 1a-c), 2, and 3 occur prior to placing a request. Steps 4-8 are part of placing a request. Steps 9 and 10 occur as part of or after fulfilling a request. In step 1, prior to sending the request, the request is created and a timestamp for when the request was created is associated with the request. Then a check may be performed to make sure that the request complies with requirements of the intended venue.

The timestamp may be created, or another timestamp may be created, just prior to, during, and/or after compliance checks are performed to check the file for compliance. In steps 2 and 3 the request is returned from compliance and (if not rejected) sent to the manager. The manager may perform workload balancing and determine which systems (e.g., user systems) are currently available and/or best suited for the task.

In step 4, the request is sent to the user system (or other system) and an authorization time is assigned. The authorization time is the time when the request is first available to the user system.

In step 5, the request is sent to the RTEA, and a time stamp is associated with the sent time, which may be labelled SEND_TIME. In step 6, the request is sent to the requesting system, and a time stamp, which may be labelled, Effective_Time, is associated with the request entering the queue of the requesting system. In steps 7 and 8, the request leaves the requesting system, and a time stamp may be associated with the request being sent by the requesting system, which may be finishTimeUtc, for example

The time at which the request enters the venue may be given a time stamp of EFFECTIVE_TIME, for example.

The time at which the request begins to execute may be associated with a timestamp. When the execution is finished another timestamp may be created, in a fill file, which may store information about the fulfillment of a request, which may have a timestamp, executedTimestampUtc. The time stamps may include the date and time (e.g., in UTC) when the fill was executed in the venue. In step 9, the information about the fulfilling of the request may be sent back to requesting system, then to the RTEA (e.g., and stored by the RTEA), and then the user system may access the information, where the request may be assigned another time stamp FINISH_TIME. Statistics may be computed to determine the average difference in time between any of the time stamps, and the standard deviation associated with the average time difference, so that one of the times stamps may be matched with another of the timestamps in situations where the private data has one time stamps and the publicly available data has another time stamp recorded, and one wants to match the two sets of data. In such a situation, for each matched transaction, one may be able to compute a probability that each match is correct based on the average difference of the two timestamps, the deviation of the difference from the average difference, the standard deviation, and an expected probability distribution of the deviations (e.g. Gaussian). One may then establish a probability of all the matches being correct by averaging or weight averaging the probabilities or by combining the deviations (e.g., by averaging the square of the deviations and taking the square root, or by another means), and the combined deviations may be used for computing the probability that the matched items are correctly matched.

FIG. 2 shows a block diagram of an embodiment of system 200 for collecting and using data. System 200 may include Real-Time Execution Application (RTEA) 202, a data collection layer 204, a normalization layer 206, a matching layer 208, a match persistence module 210, an API endpoint 212, and an application system 214. RTEA layer 202 may include a plurality of data sources 216, 218, and 220. The data collection layer 204 includes a plurality of databases 222, 224, and 226. The normalization layer 206 may include dictionary 228. Matching layer 208 may include matching logic 230 and data-lake 232. The match persistence module 210 includes one or more indices 234. System 200 also includes cloud-based system 244. In other embodiments, the system 200 may not have all of the elements or features listed and/or may have other elements or features instead of or in addition to those listed.

RTEA layer 202 may utilize data operations logic 112 to collect data from a plurality of data sources, such as database transactions, and/or memory transactions, publicly available data, data that the user does not have full knowledge of or access to, and/or other data. The data may optionally be generated by, and/or stored in RTEA layer 202 in real time as the event occurs. RTEA layer 202 may be a source of private data.

Data collection layer 204 may include a plurality of databases and/or network connections for capturing data. Data collection layer 204 may utilize data collection logic 104 to collect data from RTEA layer 202, optionally in real time as the data is being generated that the corresponding events occur. Data collection layer 204 is coupled with the RTEA layer 202 for collecting the data. Data collection layer 204 may collect data on demand in response to a user request and/or may collect data periodically for the purpose of computing indices for aligning data from different databases.

Normalization layer 206 receives the collected data and normalizes the collected data by utilizing the normalization logic 114, (e.g., by placing the data into a common format regarding of the source of the data, such as by replacing attribute identifiers of the data source with attribute identifiers used by the service provider of system 200). The collected data is normalized to facilitate consolidating (and comparing) the information from multiple data sources, so that the data may be viewed in one view or consumed (and acted upon) by the same entity. Normalization layer 206 may utilize data sorting logic 106 to sort and consolidate data captured by data collection layer 204.

Optionally, matching layer 208 utilizes alignment logic 116 to align the private data (and/or other known data to the user data associated with the user system) as normalized by normalization layer 206 (after being retrieved from RTEA layer 202, which may be the same or different than the plurality of data sources having the private data). Matching layer 208 may match data by matching the identifiers of one database (e.g., having some private data) with the identifiers of another database (e.g., having publicly available data), based on which data and/or labels from RTEA layer 202 has the highest probability of corresponding to the labels of the private data available to the user. For example, the user is aware of the requests that the user system requested and information about those requests maybe matched to publicly available data that was publicized by the venue.

Further, the matching layer 208 may utilize the vector output logic 118 to output a plurality of vectors of sequence numbers which maps the sequential private observations to the publicly available data from the other data sources. The vector output may additionally or alternatively, map parent requests to child requests.

The match persistence module 210 indexes the data based on the vectors of sequence numbers to facilitate efficient retrieval of the data stored in association with the vectors of sequence numbers and may utilize command response logic 120 to return the other data found based on the vector of sequence numbers automatically and/or based upon the user's command. The vectors of sequence numbers may be indexed and/or used to form indices. Match persistence module 210 may store and/or retain the match of the data, the views of the matched data, and/or the vectors of sequence numbers beyond the session in which the match of the data, the views of the matched data, and/or the vectors of sequence numbers were created. The indices generated and stored by match persistence module 210 may be generated relatively infrequently compared to how often the public data and/or private data changes. For example, the indices of match persistence layer may be generated once a day, even though the private data and/or the public data may be updated more frequently (e.g., continually, once every minute, once an hour).

Match persistence module 210 may utilize the data distribution logic 110 to distribute the data to user systems, which allows the users to access the collected data by utilizing and/or performing one or more operations (optionally in real time) through the user interface logic 102.

API endpoint 212 may be an Application Interface (API) that is provided at the endpoint for users and/or may be used by applications provided to the user (the users may be endpoint users). API endpoint 212 may be utilized for (1) returning to the users the publicly available data from the other data sources, (2) fetching the vector of aligned sequence numbers, by one or more processors, (3) fetching the private data and (4) creating a database view for one or more users by combining data from different datasets which optionally may involve performing a database join across the private data and/or other data known to the user system and the publicly available data that was matched on the fly.

Application system 214 may be a collection of applications that run on user systems that interact with the cloud provider system. The use system may run applications for requesting, receiving, and viewing data from the cloud provider system. For example, the application system 214 may include a collection of user systems that run applications for requesting, receiving, and/or viewing data from the cloud provider system. Application system 214 may include one or more applications that produce a statistical analysis of the data sent to the user.

Data sources 216, 218, and 220 may be RTEAs (of RTEA layer 202) from which data is collected. The plurality of data sources 216, 218, and 220 is selected based on one or more or a plurality of user objectives and/or attributes, and/or fields of the objects stored in data sources 216, 218, and 220.

Databases 222, 224, and 226 store data captured by data collection layer 204. Databases 222, 224, and 226 may be communicatively coupled, via a network (e.g., the Internet) and/or network interfaces with data sources 216, 218, and 220. Optionally, databases 222, 224, and 226 may have high speed and/or dedicated connections to data sources 216, 218, and 220. The plurality of data sources 216, 218, and 220 store the data in the plurality of databases 222, 224, and 226, which may include one or more cloud databases and/or one or more relational databases.

Dictionary 228 is a storage that stores data received from the databases 216, 218, and 220, and dictionary 228 may store the normalized data. Dictionary 228 may store a correspondence between the fields, attributes, datatypes, names of variables found in databases 216, 218, and 220 and the corresponding names for the fields, attributes, datatypes, names of variables used by the system 100 and/or presented to the user. Dictionary 228 may be used by normalization layer 206 for normalizing the data from databases 216, 218, and 220 by matching the identifiers of one database with the identifiers of another database, based on information stored in dictionary 228 related to which attributes of one system correspond to attributes that are presented to the user.

Matching logic 230 may match captured public data and private data. Matching logic may also compute a probability that the match is correct, based on the available data. For example, if the public data includes information about 10 executions and the private data includes data about one execution, if none of the public data executions match the private data execution, the percentage of matched data is 0%. If at least one of the executions in the publicly available data matches at least one execution in the private execution, there is a 100% match. If there are two executions in the private data and 10 executions in the publicly available data, but only one of the executions in the private data matches at least one execution in the public data, there is only a 50% match. In an embodiment, if there is some ambiguity about whether two executions match, each match may be weighted by the probability that the match is correct. As an example of a reason that may cause some ambiguity of whether two transactions are the same, the ambiguity may arise because the private data includes a timestamp of the time that the requesting machine sent the request to the venue, and the public data provides the timestamp of the execution time. For example, the weighting may be based on a Gaussian distribution, and the Gaussian distribution may be based on the difference between the expected mean difference or the mean difference between the two time stamps and the actual difference between the two timestamps, and a corresponding standard deviation. As an example of computing a percentage of matches that is based on weighting the matches according to a probability that the matches are correct, assume that two out of three executions in the private data each matched at least one execution in the public data. However, one of the matches has a 99% probability of being a match and the other of the matches has a 98% probability of being a match. Then the percentage of the match would be computerized as (98+99)/3=65.7%, which may be used as a measure of how likely the match is correct. Alternatively, the probabilities may be combined in another way. Matching logic 230 may also determine which data is being requested and match the data with the user request.

The data-lake 232 is a storage repository that holds the public data (and optionally private data and/or other data) in the native format of the source of the data. Databases 216, 218, and 220 may be part of data-lake 232. Alternatively, the data in data-lake 232 may have been captured from databases 216, 218, and 220. Matching logic 230 may match public data stored in data-lake 232 with privately available data. In an embodiment, the reason the data in data-lake 232 is stored in the native format of the database from which the data was captured, is so that if as more data becomes available, and as a result it being discovered that the match of the data from the databases 216, 218, and 220 was associated with the incorrect data and/or incorrect data labels of the user all of the data is present and the error can be corrected without again retrieving the data from databases 216, 218, and 220. Additionally, since the match between the user's data and the data from databases 216, 218, and 220 is probabilistic, having all the data available including the format the data facilitates reevaluating the probability that a particular match is correct and/or computing the probability of another match, based on a new request from the user, is correct. The public data in data-lake 232 may be updated periodically. In an embodiment, the public data objects are larger than the private data objects, and the public data may be updated less frequently. In an embodiment, the public data objects are updated at least as frequently as it is desired to create an index indicating how to align two data sets. Of course, the method may be applied to any combination of sets of data in which some of the data is updated at different rates (e.g., the larger sets of data may be updated slower than the smaller sets of data). The different sets of data may be stored as different types of data objects. For example, the smaller sets of data may be stored as database objects (e.g., SQL objects—objects created by and/or formatted for access by SQL). The larger sets of data may be stored as cloud storage objects (e.g., S3 objects—objects created by and/or formatted for access as an S3 object). Optionally, data-lake 232 may be updated on an ongoing basis as the public data and/or private data changes.

Indices 234 may store the vectors of sequence numbers and indices 234 returns other data found based on the vector of sequence numbers on receiving the user's commands requesting data, via the API endpoint 212. The vectors of sequence numbers may be may be created less frequently than the private data (or other data) is updated. The vectors of sequence numbers may be created less frequently than the vectors of sequence numbers are used for aligning private data and public data. By using indices 234, the user may obtain current private data that is aligned with the public data in real time or near real time.

Predefined format 236 may include a format for API calls and/or for the elements of API endpoint 212. An example of a predefined format 236 is object=get_object(ID, date). The predefined format may be a format determined by the cloud service provider. There may be multiple predefined formats, which the user may choose. Additionally, or alternatively a user may be able to establish their own predefined format.

User systems 238, 240, and 242 are systems of the users (e.g., whom may be end users and/or of agents working on behalf of a manager managed by a management system). One or more of user systems 238, 240, and 242 may be managed by management logic 128. User systems 238, 240, and 242 may run an application provided by cloud provider system 200 and/or developed elsewhere that provides a user interface for requesting, receiving, and/or viewing data from cloud provider 200. The applications of user systems 238, 240, and 242 may send functions calls to cloud provider 200, based on the API provided by API endpoint 212, having predefined format 236. The applications on user systems 238, 240, and 242, may be used for requesting data from the cloud service provider. In response to the request, the cloud service provider sends the private data, the indices, and the public data (which optionally may each be encrypted), and the application (e.g., at the user systems 238, 240, and 242) aligns the private and public data based on the index sent (alternatively the data may be aligned prior to being sent). The application may provide tools for generating statistical information related to the data received.

Cloud-based system 244 is a cloud-based system for capturing data from a variety of sources, such as RTEA layer 202, and returning the information to the user systems 238, 240, and 242, based on user requests. Cloud-based system 244 may be an embodiment of system 100 or system 100 may be an embodiment of cloud-based system 244. Cloud-based system 244 may include a normalization layer 206, a matching layer 208, a match persistence module 210, and/or an API endpoint 212. Cloud-based system 244 may store applications for user systems to download and interact with cloud-based system 244.

Cloud service provider 246 provides the cloud-computing environment on which cloud-based system 244 runs.

Network 248 may be any combination of wide area, local area, telephone, wireless, and/or computer networks. Could service provider 246 may reside in network 248.

Venue system 250 is the source of the public data. Venue system 250 is a system in which multiple entities may be perform various actions, and the actions and/or results of the actions are recorded and publicized. Although only one venue is shown, there may be any number of venues.

FIG. 3 shows a block diagram of an embodiment of a system 300 for collecting and using data. The system 300 may include a buffer-Virtual Private Cloud (buffer-VPC) 302, a private Virtual private cloud (private-VPC) 304, and a server Virtual Private Cloud (server-VPC) 306. The buffer-VPC 302 may include a batch transfer 308, a scheduler 310, one or more key managers 312 and network 314. The private-VPC 304 may include a parse/reparse 318, tables of schema 320, a computation module 322, an interface 324, and Algorithm Application Program Interface (API) 326. The server-VPC 306 may include a data store reader 332, and a public PC 334. In other embodiments, the system 300 may not have all of the elements or features listed and/or may have other elements or features instead of or in addition to those listed.

System 300 may be an embodiment of system 100 and/or system 200.

Buffer-VPC 302 is virtual storage of public data and/or private data received from the various data sources. Optionally buffer-VPS 302 is an on-demand configurable pool of shared computing resources allocated within a cloud computing platform. The buffer-VPC 302 may be a DeMilitarized Zone (DMZ) Virtual Private Cloud, for example. Buffer-VPC 302 may be a physical or logical subnet that separates an internal local area network (LAN) from other untrusted networks, such as the Internet. Optionally, external-facing servers, and/or resources, and services may be located in buffer-VPC 302, which optionally may provide accessibility via the Internet, while keeping the rest of the internal LAN unreachable. Further, buffer-VPC 302 may provide an additional layer of security to the LAN by restricting or at least hampering the ability of hackers to access internal servers and data, via the Internet directly. The buffer-VPC 302 may include Internet gateway and Network Address Translation (NAT). Buffer VPC 302 may be part of RETA 202 and/or data collection layer 204.

Private-VPC 304 may provide virtual storage of the public data received from the buffer-VPC 302 and private data received from the various data sources. Private-VPC 304 may be an on-demand configurable pool of shared computing resources allocated within a cloud computing platform. Private-VPC 304 may be accessible only by, run by, and/or used by, a private entity. Buffer-VPC 302 may establish a connection, via a raw file server unit between buffer-VPC 302 and private-VPC 304 to transmit the public data (and/or private data), which is processed in the private-VPC 304. Buffer-VPC 302 may modify files of raw data from the raw file server unit. Buffer-VPC 302 may cause only data, or at least the parts of the data that are accessible to the public, of the raw files along with the modified files (which also may only contain, or contain at least, the information that is accessible to the public) to be sent from the raw file server to the private-VPC 304. Private VPC 304 may be part of RETA 202 and/or data collection layer 204.

Server-VPC 306 is connected with the private-VPC 304 to receive the processed data in a virtual environment for further processing. Server-VPC 306 may be an on-demand configurable pool of shared computing resources allocated within a cloud computing platform. Server-VPC 306 may be accessible only by, run by, used as, and/or used by, a system of one or more servers. Server-VPC 306 may be part of data collection layer 204 and cloud-based system 244.

Batch transfer 308 enables the users to process the data received from the various data sources through data collection logic 104 in batches on cloud service provider 246, such as an AWS. Batch transfer 308 may be a cloud computing platform that provides services from one or more of data centers that may be locations in multiple availability zones (AZs) in various regions across the world. The AZs of batch transfer 308 may each represent a location that contains multiple physical data centers. The regions of batch transfer 308 may be a collection of AZs in geographic proximity connected by low-latency network links. Batch transfer 308 may utilize a protocol for exchanging files over a network such as the Internet (or other Wide Area Network), which in turn may use a transmission control protocol/Internet protocol (TCP/IP) to enable data transfer. Although, in an embodiment, transmission control protocol/Internet protocol (TCP/IP) is the protocol used to access (e.g., autmatically) the Internet another protocol may be used. The protocol may include a suite of protocols designed to establish a network of networks to provide a host with access to the Internet. The protocol used by batch transfer 308 may be a protocol that is not based on, or does not rely on, a client application. By using the protocols for exchanging files, helps batch transfer 308 share files, via the computing platform, reliably and efficiently. In an embodiment, batch transfer 308 includes an AWS batch File Transfer Protocol (FTP) (or another batch FTP). Batch transfer 308 may be part of datacollection layer 204. However, other protocols for transferring files may be used instead. The protocol may be a client server protocol (however, other types of protocols may used instead). The protocol may have a separate control and data connections between the client and the server.

Scheduler 310 enables the users to custom start and stop schedules for the instances or virtual machines of the applications that run on a cloud service provider. The scheduler 310 may further transmit the custom starts and stops, and may schedule instructions that run the batch transfer 308. The batch transfer 308 may process the data in batches based on the received custom start and stop schedules, where the schedule may be provided by the cloud-based system 244 and/or by instances or virtual machines of the applications that the cloud-based system 244 runs. Scheduler 310 may be a web-based service that facilitates the running of application programs, by the entities (e.g., the user or the cloud service provider) in the web services (e.g., AWS) of a public cloud. Scheduler 310 may facilitate a cloud infrastructure offered under the web services that provide raw computing resources on demand. Scheduler 310 may provide computing instances and/or vitual machines that may be scalable in terms of computing power and memory. In an embodiment, scheduler 310 may be an Elastic Compute Cloud (EC2) scheduler, which may be a scheduler that runs on a cloud comuting environment, such as cloud-based system 244. Scheduler 310 may be part of data collection layer 204. The cloud-computing environment, or cloud-based system 244, may provide multiple virtual computing environments, e.g., instances or virtual machines of the computing environment. Each computing environment may provide preconfigured templates for each computing environment, that package the bits needed for a server (which may include providing an operating system and/or other software). The cloud computing environment may provide different configurations (or instance types or types of virtual machines) for various configurations of CPU, memory, storage, and networking capacity for different. The cloud computing environment (e.g., of could service provider 246) may include a secure login for instances of virtual machines using asymmetric key pairs (in which the computing service stores the public key, and the service provider stores the private key in a secure place). The cloud computing environment (e.g., of could service provider 246) may provide storage volumes for temporary data that is deleted when an instance or virtual machine is terminated. Resources (such as different instances or virtual machine) of, and/or different parts of, normalization layer 206, matching layer 208, and match persistence module 210, and/or API endpoint 210 may be stored in multiple locations to facilitate quicker access). The cloud computing environment (e.g., of could service provider 246) may include a firewall that enables specifying the protocols, ports, and source IP ranges that can reach and/or use a particular instance virtual image. The cloud computing environment (e.g., of could service provider 246) may include a static addresses (e.g., IPv4 addresses) for dynamic cloud computing, (e.g., using Elastic IP addresses). The cloud computing environment (e.g., of could service provider 246) may have metadata or tags, that may be created and/or assigned to resources. Virtual networks can be created that are logically isolated from the rest of the cloud computing environment (e.g., of could service provider 246), and that can optionally connect to the virtual private clouds (VPCs). The cloud computing environment (e.g., of could service provider 246) may provide a scalable deployment of applications by providing a web service through which a user can boot a machine image (e.g., an Amazon Machine Image (AMI)) to configure a virtual machine or instance. In an embodiment, a user may create, or launch, and terminate server-instances or virtual machines as needed. The cloud computing environment (e.g., of could service provider 246) provides users with control over the geographical location of instances and/or virtual machines that allow for latency optimization and high levels of redundancy. The cloud computing environment may provide persistent storage (e.g., for the persistent matching), an SQL server, a management console, load balancing module, an auto-scaling module, and cloud monitoring services. The machine image (e.g., AMI) may be a special type of virtual appliance that is used to create a virtual machine within the computing cloud environment. Services of the cloud computing environment (e.g., of could service provider 246) may be based on the virtual appliance. The virtual appliance may include filesystem image, which may be read only. The filesystem image may include an operating system and/or additional software for delivering a service or a portion of a service.

The virtual appliance may include a template for a root volume for an instance or virtual machine (for example, a template for an operating system, an application server, and applications). The virtual appliance may control which user can launch particular instances and/or particular virtual machines. A mapping may be provided that specifies the volumes to attach to an instance and/or a virtual machine when the instance and/or virtual machine are launched. The filesystem of the virtual machine may be compressed, encrypted, signed, split into a series of chunks (e.g., of the same size) and uploaded into storage. An XML manifest file (or other file and/or tag based file) stores information about the virtual machine, including the name, version, architecture, default kernel id, decryption key and digests for all of or at least some of the filesystem chunks. The virtual machine optionally may not include a kernel image, and may have only a pointer to a default kernel identifier and/or other kernel identifier, which can be chosen from an approved list of kernels, which may be maintained by the cloud service provider and/or other parties. Users may choose kernels other than the default when booting a virtual machine. Cloud-based system 244 may run on and/or may include the cloud computing environment

Key manager 312 manages the security keys of the system. Key manager 312 may include a utility that automatically detects and updates basic input/output system (BIOS), and device drivers, and thereby detect updates to keys. Key manager 312 may manage versions on networked computing units such as computers, that update keys. Key manager 312 may store keys and/or may include encryption programs that provide cryptographic privacy and authentication for data communications between the cloud service provider, user, and/or provider of the raw data. Key manager 312 may include SSM (system software manager) FTP and/or PGP (Pretty Good Privacy) keys, which may be user keys that are used to securely transmit data via the batch transfer 308 over the Internet. Key manager 312 may manage the keys of the cloud-based system 244 (e.g., system 100 and cloud-based system 244 may be embodiments of one another). Each end user may have different keys and may have access to only the data that is relevant to that user and/or each user may have a different role. In an embodiment, the cloud service provides 244 has access to the keys of key manager 312 and/or the keys associated with each end user are only accessible by the end user, via cloud-based system 244. Key manager 312 may be part of datacollection layer 204.

Network 314 is a network that may include RTEA 202 and data sources 212-216. The data processed by the batch transfer 308 may be sent or retrieved form from RTEA 202 and/or data sources 212-216 and batch transfer 308 may be send the data to data raw data files 316.

Raw files storage 316 may store the files of raw data collected by a data source. Buffer-VPC 302 may establish a connection between raw files storage 316 and batch transfer 308. Raw files storage 316 may include one or more database servers. Raw files 316 may be stored in databases 222-226.

Parse/reparse 318 receives the data through the raw files storage 316 and parses and/or re-parses the data. In an embodiment, parse/reparse 318 is an AWS batch parse/reparse, which is a mechanism to parse or reparse the data. Parse/reparse 318 may be part of normalization layer 206 and/or matching logic 230. Optionally, how to parse or reparse the data may be determined stochastically by choosing an alignment and/or match between privately and publicly available data that maximizes the likelihood that the match is correct.

Tables of schema 320 are tables of schema of databases. Tables of schema 320 may be an object-relational database management system (ORDBMS), which may be a database management system that includes an object-oriented database model to support objects, classes, and inheritance in database schemas and query languages. Tables of schema 320 may store the parsed data in a tabular format which is uploaded by the parse/reparse 318 through a vector output logic 118. Tables of schema 320 may store tables of schema for one or more databases storing of raw files server 316. Tables of schema 320 may part of normalization layer 206, matching layer 208, matching logic 230, and/or data-lake 232.

Computation module 322 computes the alignment and/or the matching of privately available data and publicly available data, the correspondence between parent and requests and child requests and/or the vector of sequence numbers, via alignment logic 116 and/or vector output logic 118. Computation module 322 may be part of normalization layer 210, matching layer 208, and/or matching persistence module 210.

Interface 324 enables cloud-based system 244 to directly write the computed data received from the computation module 322 to the parse/reparse 318. Interface 324 may be part of cloud provider service 244,

Algorithm Application Program Interface (API) 326 is an API for accessing one or more algorithms for collecting, taking action based on information gathered, and/or manipulating information gathered. Algorithm API 326 may be a set of function calls that are handled by interface 324. Algorithm API 326 may be an embodiment of an API, via which the user systems 238-242 accesses the algorithm and/or cloud-based system 244.

Transactional database 328 stores information about transactional data, which may include original records of the tranactional data. Service database 330 stores the service related data coupled with the Algorithm API 326, which may include information about services provided, that related to the algorithms of Algorithm API 326. Transaction database 328 may be part of data-lake 232 and/or indices 234.

Data store reader 332 reads the data associated with tables of schema 320. Data sore reader may a process user input requesting to read stored data that is provided by system 100. Data store reader 332 may be part of cloud-based system 244, and may be included in API end point 212 and/or indices 234.

Public PC 334 is a computing device such as a computer or a personal digital assistant adaptable to receive the user input data and transmits the user input data to the data store reader 332. Public PC may be one of user systems 238, 240, and 242.

A user authentication module 336 to authenticate the user on receiving the user input data from the data store reader 332. User authentication module may be part of cloud-based system 244.

Application 338 may be an application, such as a javascript application, which may enable user 340 to enter input data by utilizing a user interface logic 102, and view the data provided by system 100, which may include the private data matched with the publicly available data, in real time or near real time. Application 338 may be installed on user systems 238, 240, and 242. Application 338 may be installed on user system 340. User 340 may be the user of user systems 238, 240, and 242.

### Method of Use

FIG. 4 is a flowchart of an example of an embodiment of a method 400 for collecting and using data, which may include public and private data. The data may be related to requests, executions of the requests, and/or fulfillment of the requests.

In step 402, the data is collected from a plurality of data sources, and the data collected is stored in a database through data collection logic 104. The data may include database transactions and/or memory transactions, for example. One or more sources of data may include one or more Real-Time Execution Applications (RTEAs), such as RTEA 202, and/or one or more venues, such as venue 248, which may use the data and/or update the data produced in real time. In an embodiment, some of the data associated with each Real-Time Execution Application (RTEA) may be referred to as publicly available data, which is data that is publicly available (e.g., by venue 248). However, there may be private data that is associated with the public data, which may be known to, but not made public by venue 248. The private data may be known to individual users and/or to RTEAs 202, cloud based service 244 may learn about, as result of having access to at least some of the private, as a consequence of servicing user systems 238-242. For example, the publicly available data may be data that is reflective of activities of individuals (e.g., individual animals, individual machines, or individual vehicles, and/or individual people), but which does not include information identifying individuals. In other words, the publicly available data has some aspects to the data that are not fully known, but may be mostly known. At least some of the data associated with each RTEA may be fully known. For example, private data associated with the user system requesting the data or that needs the data and/or may be data that is fully known for other reasons. The collected data may be collected by data collection logic 104, data collection layer 204, and/or buffer VPC 302. Some of the data (e.g., data collected from RTEA layer 202) may be collected, in real time, near real time, and/or on demand. In step 402, data from the plurality of data sources (which may include RTEA layer 202 and venue 248) may be stored the data in data-lake 232. Data-lake 232 may include and/or include data from, transactional database 328 and/or service database 330, which may be a cloud database (e.g., as an S3 object) and/or a relational database (e.g., as an SQL and/or database object). The plurality of data sources is selected based on requests from user systems 238-242.

In step 404, the collected data is normalized through normalization logic 114, normalization layer 206, dictionary 228, private VPC 304, and/or parse/reparse 318. The normalization may be performed by placing the data into a predetermined format, which may facilitate consolidating the information, from multiple data source, across the data sources, so that the data may be viewed in one view or consumed (and acted upon) by the same entity (e.g., users 238-242 and/or end user 340).

In step 406, the private data (or the data known to user systems 238-242 and/or end user 340), which may be retrieved from the plurality of sources (e.g., RTEA layer 202) may be aligned with the publicly available data (e.g. data from venue 248 that stored in data-lake 232). The publicly available data may come from a variety of data sources (which may be the same or different than the plurality of data sources having the private data), and may be aligned with the private data by alignment logic 116, matching logic 230, and/or matching layer 208. The other data sources include but are not limited to sources of data about transactions. The data may optionally include data that is updated in real-time or in near real-time data. The alignment may include matching the identifiers of one database (having private data) with the identifiers of another database (having publicly available data). The database of identifiers 126 may include dictionary 228 and may be configured with a memory system 124. The output of the step 406 may include a plurality of vectors of sequence numbers which maps the sequential private observations to the publicly available data from the other data sources and/or may map child requests to parent requests.

In step 408, one or more vectors of sequence numbers are generated (and optionally stored in one or more databases) by vector output logic 118. The databases may include databases of the system for retrieving the data (databases 222-226, data-lake 232, transactional database 328, service database 330, and/or raw data 316) and/or databases of the user step 408 may be a sub-step of step 406).

In step 410, the other data found is returned based on the vector of sequence numbers upon receiving the user's command, via an API through command response logic 120. Step 410 may utilize processor system 122 for (1) returning the publicly available data from the other data sources, (2) fetching the vector of aligned sequence numbers, (3) fetching the private data, for example, and (4) optionally creating a database view by performing a database join across the private data or data known to the user system and the publicly available data that was matched on the fly, based on one or more of the indices of inidices 236 (which may be the vector of sequense numbers).

In step 412, the data is distributed to a plurality of user systems by using data distribution logic 110 to access the collected data by utilizing and/or perform one or more operations through data operations logic 112. The users may need the collected data in real time or near real time from the point of collecting at least some of the data (e.g., from the time of collecting the private data). The data may be acted upon in real time, and optionally the data and/or activities based on the data may be displayed through a GUI of user interface logic 102.

Although the system and method have been described in terms of public and private data, the system and method may be used in any two sets of data that may be matched. In particular, the method may be useful in any situation in which an index for aligning the two sets of data may be computed less often than at least one set of data is collected and analyzed. For example, if one set of data is large and/or complex and therefore requires a relatively long time to download and/or analyze, then it may be advantageous to compute the an index for aligning the data once, and then use the index multiple times prior to recalculating the index or more up-to-date data.

FIG. 5 shows a representation of an example of vector of sequence numbers in which the patent requests and child requests have been matched.

### Examples of Applications of the Method

Best route selection or traffic abuse detection- data can be collected from different sources and in different formats about internet traffic and/or road traffic, and it is desirable to choose the best route, model the traffic, or detect abuse of the traffic system. The information about the traffic on the different routes may be stored in a multiplicity of the different database in a multiplicity of formats that need to be aligned in real time to plot the best route. In an embodiment related to network traffic, the public data may be data about the overall traffic flow the private data may be data about the transport of individual traffic sent by and/or received by a user system. In the case of road traffic, the private data may also include observations about other vehicles and/or entities in the vicinity of the user's vehicle. In the case of the road traffic the public data may also include information about vehicles in the vicinity of the user, which may be collected in real time and/or may include information about the traffic flow overall, which may be collected less frequently, such as once per day.

Robotic decision making- the presence of various autonomous robots in an unknown environment which are made by different manufacturers and each of the robot having its own task. Each robot may have its own database format/schema and sees a number of different unknown objects and/or unknown object types (e.g., a tree, a person, a sidewalk, a car), and needs information about the objects it detects. The control center needs to find a database with information about each object and type of object from a variety of online databases, where each has their own database schema. The robots in some cases need some of the information (e.g., information about moving objects in the immediate vicinity of the robot) in real time to make immediate decisions (e.g., to avoid being run over by a car). However, the robots may obtain other information less frequently, such as more general information about the landscape and/or information about stationary objects. The information needed less frequently may be used, by the system, to make a more extensive model, which is updated with the information needed more frequently, to make immediate decisions. The system may match the slowly changing data or more complex with the data that changes more rapidly based on indices, which may be vectors of sequence identifiers, where the index is computer less frequently than the more rapidly change data changes, so as to align new data quickly.

The applications of the present system and method include but not limited to market abuse, simulation, trade cost analysis, optimizing trading behavior. Regarding market abuse, the system and method provide the ability to screen the transactional data against a suite of pattern recognition algorithms which encode known market abusive behaviors. Regarding simulation, the system and method provide a simulation of a realized profit and loss (i.e., ex-post) distribution should match the simulated profit and loss (i.e., ex-ante) distribution for a given signal over the same period. Commonly it is seen that the two distributions do not match which is problematic because the simulation is how new trading signals are chosen. By calibrating against the transactional data, simulation parameters can be learned, ensuring that out of sample simulations will accurately match what is realized. Regarding trade cost analysis—the system and method may provide analysis of how a given trading signal was executed, allows future execution to be improved. There are a variety of mechanisms in this related to trading including Smart Order Routing and broker selection. Regarding optimizing trading behavior—in a real-time environment, a trader has to execute a portfolio of metaorders. To do execute the portfolio of metaorders optimally, the trader may need predict what the distribution will be N steps ahead of the current step for a marginal the transactional data. The indices may be computer so as optimize how to break a metaorder into children and the associated timing of when to execute each child order. In the context of trading, the public data may be referred to as L3 data and the private data may be referred to as L4 data. When data is requested by the user, all of the L3 data for a particular security may be sent with the L4 data (and the index). The L3 data is collected from the exchange, whereas the L4 data is collected from the RTEAs, which may be an execution management system. The process of matching user identifiers with data found may be computationally demanding, and so the matching may be done on a batch basis using a distributed server farm with calculations performed per security per date.

“Limit Order Books,” Authors: M. D. Gould, M. A. Porter, S. Williams, M. McDonald, D. J. Fenn, and S. D. Howison, Quantitative Finance, vol. 13, no. 11, pp. 1709-1742, 2013 (which is incorporated herein by reference) relates to limit order books and the type of data to which the methods in the specification may be applied.

“Maximum Likelihood from Incomplete Data via the EM Algorithm,” Authors: A. P. Dempster, N. M. Laird and D. B. Rubin, Journal of the Royal Statistical Society. Series B (Methodological), Vol. 39, No. 1 (1977), pp. 1-38, (which is incorporated herein by reference) is an example of an expectation maximization algorithm that may be used for aligning data in the specification.

### Alternatives and Extensions

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
retrieving, by a machine system, at least a portion of the publicly available data from the source, the machine system including a memory system and a processor system that has one or more processors in one or more machines and;
retrieving, by the machine system, private data;
determining, by the processor system, a plurality of possible associations between elements of the private data and elements of the public data; and
determining, by the machine system, one association of the plurality of associations that is most likely a match, computing an index for aligning newly acquired private data with the public data based on the index.

2. The method of claim 1, further comprising normalizing, by the machine system, the data, by placing the portion of the public data, which was retrieved, into a predetermined format.

3. The method of claim 1, based on the computing of the index, outputting one or more vectors of sequence numbers mapping the private data to the public data.

4. The method of claim 3, further comprising: matching other public data to the private data based on the one or more vectors.

5. The method of claim 1, the determining of the one association of the plurality of associations that is most likely a match, further comprising matching identifiers of attributes of the publicly available data with attributes of data associated with the machine system.

6. The method of claim 5, further comprising: replacing attribute identifiers of a data source with attribute identifiers associated with the machine system.

7. The method of claim 1, where the publicly available data is updated at a first frequency, and the index is updated at second frequency that is a lower frequency than the first frequency.

8. The method of claim 1, receiving a command from a user system, via an Application Interface (API), and, on demand, returning results of implementing the command, via the index.

9. The method of claim 1 further comprising: storing the public data retrieved, in a cloud based database.

10. The method of claim 1, wherein the retrieving of the public data including performing a batch transfer of the publicly available data from a publicly available database to data store associated with the machine system.

11. The method of claim 1, wherein the retrieving of the public data including performing a batch transfer of the publicly available data from a publicly available database to data store associated with the machine system.

12. The method of claim 1, the publicly available data being retrieved from a plurality of different public database, in which at least a first publicly available database of the plurality of different public databases is associated with a first format and a second publicly available database of the plurality of different public databases is associated with a second format;
the method further comprising:
storing, by the machine system, data from the first publicly available database of the plurality of different public databases, in a data-lake in the first format; and
storing, by the machine system, data from the second publicly available database of the plurality of different public databases, in the data-lake, in the second format;
the data-lake being different than the first publicly available database and the data-lake being different than the second publicly available database.

13. The method of claim 1, further comprising:
receiving a request from a user system after the index is computed, and
returning results of the request based, on the index that was computed and updates to the publicly available data that occurred after computing the index;
wherein because the returning of results is based on
the index that was already computed and
the updates to the publicly available data that occurred after computing the index,
the machine system is capable of returning the results on-demand, even in cases where updating the alignment on-demand, by the machine system, was not possible without the index that was already computed.

14. A machine system comprising:
a processor system that has one or more processor located in one or more machines of the machine system, and
a memory system, the memory system including one or more machine instructions, which when implemented cause the machine system to implement a method including at least,
retrieving, by the machine system, at least a portion of the publicly available data from the source;
retrieving, by the machine system, private data;
determining, by the processor system, a plurality of possible associations between elements of the private data and elements of the public data; and
determining, by the machine system, one association of the plurality of associations that is most likely a match, computing an index for aligning newly acquired private data with the public data based on the index.
